(19) United States
(12) Patent Application Publication
(10) Pub. No.: US 2012/0221369 A1
(43) Pub. Date: Aug. 30, 2012

(54) METHOD, APPARATUS AND COMPUTER PROGRAM PRODUCT FOR SUGGESTING IMPERFECT TIMES FOR CYCLICAL APPOINTMENTS

(75) Inventors: Kent Braatem, Burnsville, MN (US); David Carlson, Shoreview, MN (US)

(73) Assignee: McKesson Financial Holdings

(21) Appl. No.: 13/034,153

(22) Filed: Feb. 24, 2011

(51) Int. Cl. G06Q 10/00; G06Q 50/00

(52) U.S. Cl. 705/7.19

(57) ABSTRACT

A method for developing cost-effective pathways for treatment using an evidence-based approach may include enabling suggestions of imperfect times for cyclical appointments may include receiving availability information defining available periods for a healthcare related asset, receiving appointment parameters defining a number and frequency of recurring appointments to be scheduled, determining, via processing circuitry, periods of overlap between the available periods and the appointment parameters, and determining an inconsistent schedule pattern based on the periods of overlap. A corresponding computer program product and apparatus are also provided.

### TECHNOLOGICAL FIELD

Embodiments of the present invention relate generally to scheduling solutions and, more particularly, relate to a mechanism for providing suggestions for appointment times when perfectly cyclical appointments are not possible.

### BACKGROUND

Many aspects of the provision of medical care and the management of many aspects of the healthcare system now involve the use of computers and computer applications. With clinical documentation systems moving to electronic media, clinical data may be available for incorporation into a number of different applications designed to assist in the management or use of such data. Applications have also been developed to handle scheduling of appointments and other healthcare related activities.

Some of these appointments may be single events without any follow-up appointments being associated therewith. However, many appointments such as physical therapy appointments or certain treatment regimens may include several appointments. When multiple appointments are needed, it is quite common to schedule those appointments in a regular and cyclic fashion. For example, weekly or bi-weekly appointments are often scheduled at a consistent time on the same day of the week. This type of scheduling is generally preferred by patients, since regular/cyclic appointments are easier to remember and since people often themselves maintain relatively consistent routines in their own daily schedules making it easier for them to set aside time at a consistent time of day and day of the week. Consistent cyclic scheduling may also be preferred by healthcare providers hoping to maximize the likelihood that the appointment will be kept, and understanding that patients prefer consistent appointments as an indicator of quality customer service. Moreover, typical scheduling programs only have the ability to suggest consistent patterns in relation to cyclic scheduling. However, when schedules start to fill up, the likelihood of conflicts preventing consistent schedules from being provided for cyclical appointments begins to increase. While computers have a difficult time dealing with situations where imperfect results are encountered, people are generally better equipped to handle situations involving imperfect results in simple scenarios or scenarios that do not involve large amounts of data. However, humans are often unable or unwilling to expend the energy needed to handle more complex or time consuming scheduling problems.

### BRIEF SUMMARY

A method, apparatus and computer program product are therefore provided to enable the provision of an automated system that can deal with schedule conflicts that prevent consistent scheduling. In this regard, some embodiments may provide a system configured to suggest imperfect times for cyclical appointments. Moreover, in some cases, example embodiments may still keep relatively close to a consistent pattern, but minimize deviations or at least keep deviations from the pattern low when suggesting an imperfect cyclic schedule.

In one example embodiment, a method for providing suggestions for appointment times is provided. The method may include receiving availability information defining available periods for a healthcare related asset, receiving appointment parameters defining a number and frequency of recurring appointments to be scheduled, determining, via processing circuitry, periods of overlap between the available periods and the appointment parameters, and determining an inconsistent schedule pattern based on the periods of overlap.

In another example embodiment, a computer program product for providing suggestions for appointment times is provided. The computer program product may include at least one computer-readable storage medium having computer-executable program code instructions stored therein. The computer-executable program code instructions may include program code instructions for receiving availability information defining available periods for a healthcare related asset, receiving appointment parameters defining a number and frequency of recurring appointments to be scheduled, determining, via processing circuitry, periods of overlap between the available periods and the appointment parameters, and determining an inconsistent schedule pattern based on the periods of overlap.

In another example embodiment, an apparatus for providing suggestions for appointment times is provided. The apparatus may include processing circuitry. The processing circuitry may be configured for receiving availability information defining available periods for a healthcare related asset, receiving appointment parameters defining a number and frequency of recurring appointments to be scheduled, determining, via processing circuitry, periods of overlap between the available periods and the appointment parameters, and determining an inconsistent schedule pattern based on the periods of overlap.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for use in connection with providing suggestions for appointment times according to an example embodiment of the present invention;

FIG. 2 is a block diagram showing various components that may be included in an apparatus for providing suggestions for appointment times according to an example embodiment of the present invention;

FIG. 3 is a block diagram according to an example method for providing suggestions for appointment times according to an example embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which to provide suggestions for appointment times, particularly in situations where consistent scheduling is not possible, for any reason. In the context of the present disclosure the term “consistent” or “perfect” as it relates to scheduling, should be understood to correspond to schedules that recur with regularity in accordance with a pattern. The pattern may include as few as two and up to very large numbers or even indefinite numbers of repetitive events (e.g., appointments or other activities). In an example embodiment, a perfect or consistent schedule involves scheduling an event at the same time of day and on the same day of the week each time the event recurs. Thus, for example, an appointment that occurs every Thursday (or even every other Thursday or every third Thursday of the month) at 4:00 PM may be considered to be a consistent schedule. However, if multiple weekly appointments are included, the schedule may be considered to be consistent if the event is scheduled for the same time of day each time it occurs on one of the scheduled days of the week. For example, a cyclic schedule of appointments every Tuesday and Thursday at 4:00 PM on each of those days would be considered to be consistent. However, a cyclic schedule of appointments every Tuesday and Thursday where the Tuesday appointment is at 4:00 PM and the Thursday appointment is at 4:30 PM would not be considered to be consistent.

Computers are very good at picking out consistent schedules. Thus, if a patient is to have a series of appointments scheduled, a computer can quite easily identify opportunities for consistent scheduling and suggest available options for presentation to the patient. However, if no consistent appointment options are available (e.g., because conditions associated with scheduling one or more of the appointments at a consistent time cannot be met), and the computer is, therefore, not able to identify any options for consistent appointments (at least within parameters that may be provided by the patient or the facility servicing the appointment), the computer is often unable to provide any suggestions for suitable alternatives. Some example embodiments may address this issue by enabling automated appointment suggestion options to be determined even in situations where consistent scheduling is not possible. For example, some embodiments may provide for a scoring paradigm to be devised to enable suggestions to be made for imperfect or inconsistent schedules. Moreover, the scoring paradigm may enable the establishment of a schedule of appointments that can be suggested to patients that comes close to being a perfect or consistent schedule. The scoring paradigm may use weighting values to identify schedules that are close to being consistent and providing suggestions accordingly. In this regard, for example, some embodiments may provide for selection of a base pattern that would be consistent but for a relatively small number of discrepancies. Then the discrepancies may be resolved using options that are again weighted to provide for selection of options that minimize or at least provide a relatively low amount of deviation from the base pattern.

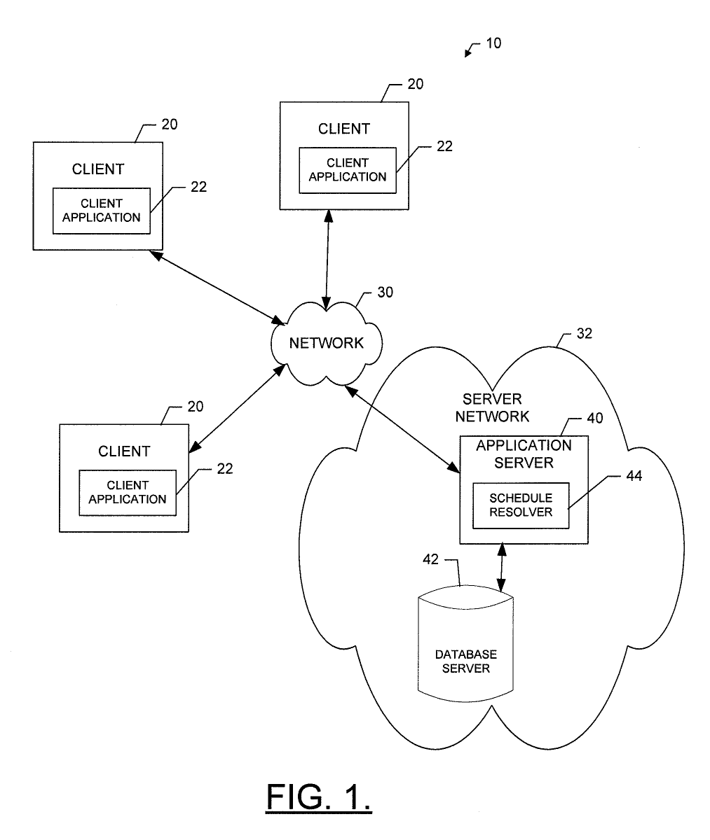

An example embodiment of the invention will now be described in reference to FIG. 1, which illustrates an example system in which an embodiment of the present invention may be employed. As shown in FIG. 1, a system 10 according to an example embodiment may include one or more clients 20 that may, in some cases, be associated with different corresponding healthcare related entities associated with one or more healthcare organizations or systems. For example, one client 20 may be associated with a first facility and a second client 20 may be associated with a second facility. The facilities (and the corresponding clients) may be within the same healthcare organization or system or the facilities could be associated with different healthcare organizations or systems. As such, in some cases, multiple clients may be associated with the same organization.

Each client 20 may be, for example, a computer (e.g., a personal computer, laptop computer, network access terminal, or the like) or may be another form of computing device (e.g., a personal digital assistant (PDA), cellular phone, or the like) capable of communication with a network 30. As such, for example, each client 20 may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for the provision of and receipt of information associated with facility usage and scheduled events or appointments corresponding thereto. As such, for example, the client application 22 may include corresponding executable instructions for configuring the client 20 to provide corresponding functionalities for the provision of and receipt of information associated with the availability of the facility, or equipment and personnel associated with the facility, such as doctors, staff, specific machinery, specific rooms or types of rooms, or other facility assets as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an example embodiment, one of the devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the collection of information from multiple facilities to enable the consolidation of information regarding the availability of assets of the facilities for scheduling purposes and, in some cases, storing such information at the database server 42. In some embodiments, for example, the application server 40 may include a schedule resolver 44 comprising stored instructions for handling activities associated with practicing example embodiments as described herein.

Additionally or alternatively, the application server 40 may be configured to enable the clients 20 to provide information to the application server 40, for use by the application server 40 in producing, maintaining and/or supplying scheduling information. In this regard, for example, the application server 40 (or servers) may include particular applications related to various different data entry, management and/or storage modules. As such, some application servers may host data entry mechanisms that enable the entry of various different types of information, perhaps with different formats and protocols, to be received and processed and/or translated as needed to permit storage in the database server 42 in a manner that will enable extraction of needed information for schedule resolution as described herein. In other words, the database server 42 may form a storage repository to accept schedule information that may arrive in various forms, but can be maintained in a form that is useable by the application server 40 (or at least the schedule resolver 44) to be processed for schedule generation as described herein.

In an example embodiment, the application server 40 may include or have access to memory (e.g., internal memory or the database server 42) for storing instructions or applications for the performance of various functions and a corresponding processor for executing stored instructions or applications. For example, the memory may store the schedule resolver 44 configured to operate in accordance with an example embodiment of the present invention. In this regard, for example, the schedule resolver 44 may include software for enabling the application server 40 to communicate with the network 30 and/or the clients 20 for the provision and/or receipt of information associated with providing persistent storage of data that is accessible for querying via a user friendly interface. As such, for example, the client application 22 may include corresponding executable instructions for configuring the client 20 to request information (e.g., via the schedule resolver 44) regarding the availability of facility assets for scheduling purposes to enable the presentation of the scheduling information at the client 20. The schedule resolver 44 may therefore be configured to provide corresponding functionalities for the provision and/or receipt of scheduling information and specifically for resolving inconsistent schedule issues as described in greater detail below.

As such, the environment of FIG. 1 illustrates an example in which scheduling of events related to the assets (e.g., doctor, staff member, team, room or group of similar rooms, piece of equipment, and/or the like) of multiple facilities may be accomplished by a central facility (namely the schedule resolver 44 residing at the application server 40). However, it should be noted that the schedule resolver 44 could alternatively handle scheduling within a single facility. Thus, in some embodiments, the schedule resolver 44 may be embodied at one or more of the clients 20 and, in such an example, the schedule resolver 44 may be configured to handle scheduling only for the corresponding facility.

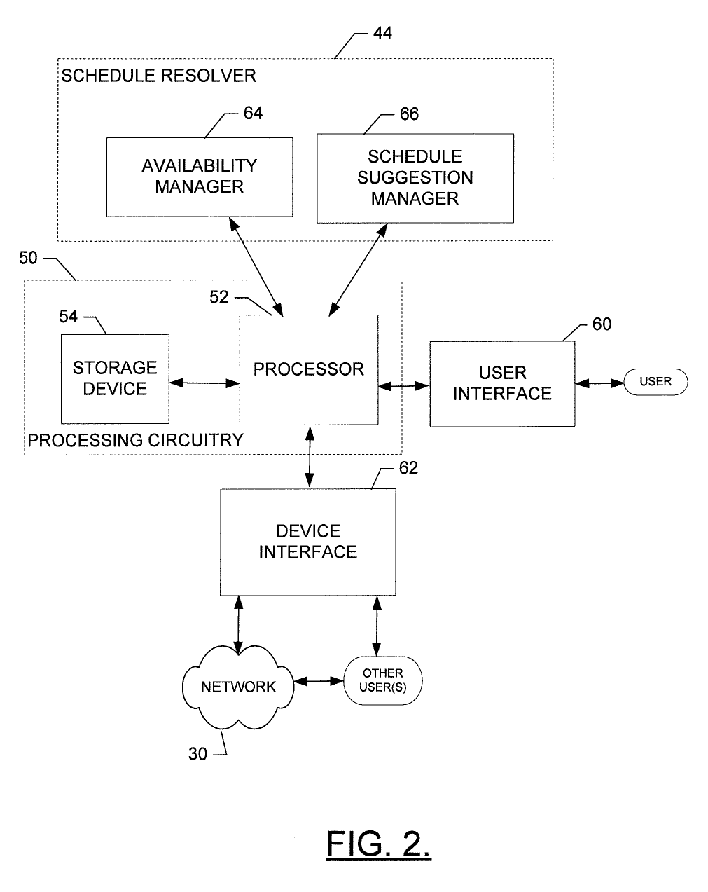

An example embodiment of the invention will now be described with reference to FIG. 2. FIG. 2 shows certain elements of an apparatus for providing suggestions for appointment times according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for providing suggestions for appointment times is provided. The apparatus may include or otherwise be in communication with processing circuitry 50 that is configured to perform data processing, application execution and other processing and management services according to an example embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or schedule resolver 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the schedule resolver 44, which may include or otherwise control an availability manager 64, and a schedule suggestion manager 66. The availability manager 64, and the schedule suggestion manager 66 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the availability manager 64, and the schedule suggestion manager 66, respectively, as described below.

The availability manager 64 may be configured to receive scheduling information indicative of the availability of one or more assets of a facility. The scheduling information may include time slots (e.g., in terms of hours, or portions of hours) in calendar form and an indication as to what (if any) event is associated with each corresponding time slot. When a time slot is taken (e.g., by an event being associated therewith), the corresponding period of time is a period of unavailability. If a time slot is not taken (e.g., having no event associated therewith), then the time slot may be considered to be available if no availability rule precludes such consideration. The availability of an asset may be impacted by any of a number of events or situations. For example, if the facility has operating hours, the availability of an asset of the facility may be limited to time periods within the operating hours of the facility. In some cases, operating hours may be designated by scheduling rule, or non-operating hours may be indicated as being unavailable through the association of an event (e.g., closed) with all non-operating hours. Scheduled events or appointments may also impact availability. For example, if an event such as training or vacation of a staff member, or maintenance on a piece of equipment is already scheduled, the scheduling information may indicate unavailability of the corresponding asset at the corresponding time slot(s).

Each asset (e.g., doctor, staff member, team, room or group of similar rooms, piece of equipment, and/or the like) may have its own schedule in some cases. Thus, scheduling information may be provided to the availability manager 64 to enable the availability manager 64 to handle determinations as to periods of availability for the corresponding asset when a query is received (e.g., via the user interface 60 or device interface 62). Queries regarding asset availability may include an identification of the asset for which availability information is sought. In some cases, availability parameters may also be provided to bound searches for availability. For example, a query may be received with respect to the availability of an examination room on Mondays or Tuesdays, or on Mondays or Tuesdays after 2:00 PM, or on Mondays or Tuesdays between the hours of 9:00 AM and 11:30 AM. Based on availability parameters, availability rules, and existing scheduled events, all available periods may be identified by the availability manager 64.

In an example embodiment, the available periods identified by the availability manager 64 may be communicated to the schedule suggestion manager 66. The schedule suggestion manager 66 may be configured to utilize appointment parameters and the available periods for one or more assets associated with a particular appointment in order to suggest a schedule for recurring appointments (e.g., at least two appointments associated with the same healthcare condition). Moreover, the schedule suggestion manager 66 may be configured to suggest such a schedule even when a consistent cyclic schedule is not possible. In other words, the schedule suggestion manager 66 may be configured to suggest a cyclic schedule that is inconsistent, when needed.

The appointment parameters may identify requirements for the appointment to be scheduled in terms of a number of recurring appointments and a periodicity or frequency. As such, the appointment parameters may identify whether scheduling for two appointments is requested, whether scheduling for an infinite number of appointments is requested, or whether scheduling of any number of appointments in between is requested. The appointment parameters may also identify the periodicity or frequency as a number of appointments per a given period of time. Thus, the periodicity could be once, twice, three times, or the like, over a given period (e.g., weekly, bi-weekly, monthly, etc.). The appointment parameters may represent an order (e.g., from a doctor or other practitioner) defining a series of appointments or events that must be made and the period over which those appointments are to be made. As such, the appointment parameters may define practitioner constraints (e.g., requirements for the number and periodicity of appointments) for the scheduling of utilization of a particular asset by a patient. In some examples, however, the appointment parameters may further include patient constraints that identify patient availability, preferences, or requirements with respect to scheduling.

In some embodiments, the schedule suggestion manager 66 may initially attempt to determine whether a consistent appointment schedule is possible given the available periods for the asset (or assets) associated with an appointment to be scheduled and the corresponding appointment parameters. As such, the schedule suggestion manager 66 may examine the available periods for the asset and the appointment parameters to determine whether a series of appointments can be made on the same day of the week and at the same time of day for each of the appointments needed over the periods of time defined by the appointment parameters. If a consistent appointment schedule is not possible, the schedule suggestion manager 66 may transition to determining best available options for inconsistent appointments.

When attempting to determine available options for inconsistent appointments, some embodiments may employ a scoring strategy that gives high scores to inconsistent appointments that, although inconsistent in some regard, have a relatively low amount of deviation from a consistent pattern. In an example embodiment, each deviation from a consistent pattern may deduct from the score that would otherwise be provided for a consistent pattern. Thus, for example, a consistent pattern may have a perfect or at least highest possible score, and any pattern that is inconsistent may deduct from that score for each deviation. Deviations from the pattern may be any parameters that differ from the parameters of a consistent pattern. Thus, for example, deviations may include a change with respect to the time of day or a change with respect to the day of the week. In some cases, each appointment for which there is a change with respect to the time of day or a change with respect to the day of the week may count as a deviation. Thus, for example, if four weekly appointments are needed and a consistent schedule of every Wednesday at 4:00 PM is not possible since the corresponding asset is unavailable at 4:00 PM on one of the Wednesdays (e.g., the third Wednesday in the series), moving the time of the appointment to another time on the third Wednesday may be counted as a single deviation (e.g., a deviation in time of day). Similarly, moving the appointment to a different day of the week (e.g., the third Tuesday or Thursday), but keeping the same time may be counted as a single deviation. However, moving the appointment to a different day and time may count as two deviations.

In some cases, each deviation may have a fixed value. However, in other example embodiments, deviations may have different values based on the type of deviation and/or the magnitude of the deviation. For example, a deviation with respect to time of day could weigh more or less than a deviation with respect to day of the week. As another example, a one day deviation (or one hour deviation) may weigh less than a two day deviation (or two hour deviation). Accordingly, some example embodiments may define a hierarchy of scoring combinations. In an example embodiment, the highest score may generally be associated with combinations that provide the same time of day and day of the week for appointments of a particular period throughout the course of the appointments. A next highest score may be provided for appointments that keep the same time of day for all appointments, but allow for a different day to be utilized for one appointment. A next highest score may be provided in a situation where a different day is needed for multiple appointments, but the same different day is available at a consistent time of day. For example, if five appointments are spread over five weeks and the basic pattern would be every Monday at 9:00 AM, but two Mondays are booked at 9:00 AM over the period covered, moving both of those appointments to 9:00 AM on a corresponding Tuesday would satisfy the preceding scenario.

It should be appreciated, however, that it is possible to reorder the hierarchy to adjust the scores to any desirable order. Moreover, although the examples above relate to an embodiment in which higher scores are desirable, a simple paradigm shift could be employed to make lower scores more desirable and have deviations count in a positive direction to result in a higher score that is indicative of a less desirable combination.

Some example embodiments may therefore employ the schedule suggestion manager 66 to receive availability information (e.g., defining available periods for the asset) and appointment parameters (e.g., defining practitioner constraints and/or patient constraints) to determine overlapping periods of time that are common to every one of, or at least a majority, of the appointments. If one or more overlapping periods of time are found for every one of the appointments, one or more corresponding consistent schedule options may be presented or suggested. The patient (or an operator receiving patient input) may then select from available consistent schedule options to accept an appointment schedule. If no consistent schedule options are available (or the available consistent schedule options are declined by the patient), the schedule suggestion manager 66 may be configured to search for inconsistent schedule options. In searching for inconsistent schedule options to suggest, the schedule suggestion manager 66 may be configured to again determine overlapping periods for the availability information and appointment parameters to identify periods that fit a majority, or at least over a threshold amount, of the appointments to be scheduled. Those periods that do not fit may be replaced with suggested other periods that are “close” to the otherwise consistent periods that are not overlapping. Again, one or more schedule options may then be presented or suggested, and the patient (or an operator receiving patient input) may select from available inconsistent schedule options to accept an appointment schedule.

Example embodiments may therefore enable automated scheduling suggestions to be presented even in situations where a perfectly consistent schedule is not possible. Thus, operator input to sort through schedule options to manually locate available alternative scheduling options may be avoided when a consistent schedule is not possible. Inconsistent scheduling options may therefore be provided more quickly and perhaps also with more options that are likely to be acceptable to patients. Customer service may therefore be improved and patient satisfaction correspondingly enhanced.

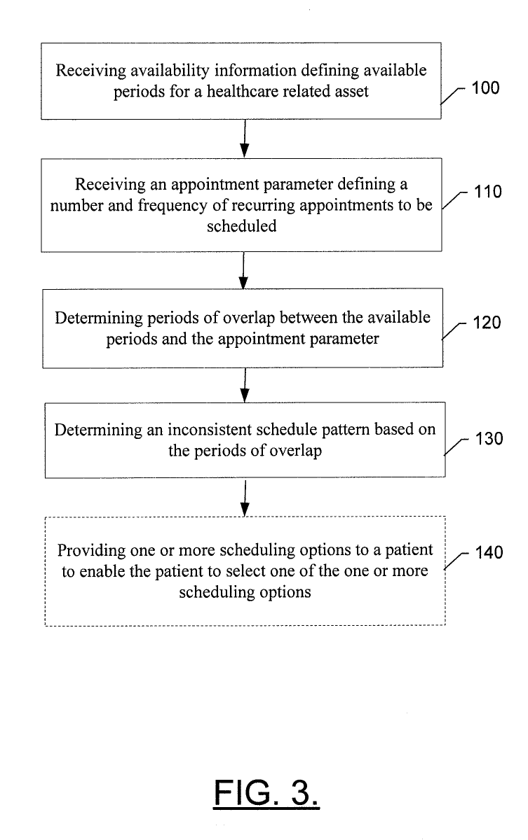

Embodiments of the present invention may therefore be practiced using an apparatus such as the one depicted in FIG. 2. However, other embodiments may be practiced in connection with a computer program product for performing embodiments of the present invention. FIG. 3 is a flowchart of a method and program product according to example embodiments of the invention. Each block or step of the flowchart of FIG. 3, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable storage medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one embodiment of the invention, as shown in FIG. 3, may include receiving availability information defining available periods for a healthcare related asset at operation 100, receiving appointment parameters defining a number and frequency of recurring appointments to be scheduled at operation 110, determining periods of overlap between the available periods and the appointment parameters at operation 120, and determining an inconsistent schedule pattern based on the periods of overlap at operation 130.

In some cases, the method may include additional optional operations, an example of which is shown in dashed lines in FIG. 3. Any additional operations, and/or modifications to the operations above or the additional operations, may be performed in addition to the operations described above in any order and in any combination. Thus, in some embodiments, all of the additional operations or modifications may be practiced, while in others none of the additional operations or modifications may be practiced. In still other embodiments, any combination of less than all of the additional operations or modifications may be practiced. In an example embodiment, the method may further include providing one or more scheduling options to a patient to enable the patient to select one of the one or more scheduling options at operation 140. In some embodiments, receiving the appointment parameter may include receiving practitioner constraints or patient constraints. In an example embodiment, determining the inconsistent schedule pattern may be performed responsive to an inability to determine a consistent schedule pattern. In some cases, determining the inconsistent schedule pattern may include scoring alternative scheduling options based on an amount of deviation from a consistent schedule option. In some embodiments, determining the inconsistent schedule pattern may include selecting overlap periods that follow a consistent pattern for at least a threshold number of appointments and, for periods that do not follow the consistent pattern, selecting an alternative period having a relatively small amount of deviation from the consistent pattern (e.g., an alternative period having a smaller deviation from the consistent pattern than other overlap periods that do not follow the consistent pattern). In an example embodiment, an amount of deviation may be based on a number of changes from the consistent pattern or a magnitude of change from the consistent pattern. Other modifications are also possible. The modifications and optional operations may be included in any combination and in any order with respect to the operations 100-140 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving availability information defining available periods for a healthcare related asset;
receiving an appointment parameter defining a number and frequency of recurring appointments to be scheduled;
determining, via processing circuitry, periods of overlap between the available periods and the appointment parameter; and
determining an inconsistent schedule pattern based on the periods of overlap.

2. The method of claim 1, wherein receiving the appointment parameter comprises receiving practitioner constraints.

3. The method of claim 1, wherein receiving the appointment parameter comprises receiving patient constraints.

4. The method of claim 1, wherein determining the inconsistent schedule pattern is performed responsive to an inability to determine a consistent schedule pattern.

5. The method of claim 1, wherein determining the inconsistent schedule pattern comprises scoring alternative scheduling options based on an amount of deviation from a consistent schedule option.

6. The method of claim 1, wherein determining the inconsistent schedule pattern comprises selecting overlap periods that follow a consistent pattern for at least a threshold number of appointments and, for periods that do not follow the consistent pattern, selecting an alternative period having a relatively small amount of deviation from the consistent pattern.

7. The method of claim 6, wherein an amount of deviation is based on a number of changes from the consistent pattern or a magnitude of change from the consistent pattern.

8. The method of claim 1, further comprising providing one or more scheduling options to a patient to enable the patient to select one of the one or more scheduling options.

9. An apparatus comprising processing circuitry configured to:
receive availability information defining available periods for a healthcare related asset;
receive an appointment parameter defining a number and frequency of recurring appointments to be scheduled;
determine periods of overlap between the available periods and the appointment parameter; and
determine an inconsistent schedule pattern based on the periods of overlap.

10. The apparatus of claim 9, wherein the processing circuitry being configured to receive the appointment parameter comprises the processing circuitry being configured to receive practitioner constraints or patient constraints.

11. The apparatus of claim 9, wherein determining the inconsistent schedule pattern is performed responsive to an inability to determine a consistent schedule pattern.

12. The apparatus of claim 9, wherein the processing circuitry being configured to determine the inconsistent schedule pattern comprises the processing circuitry being configured to score alternative scheduling options based on an amount of deviation from a consistent schedule option.

13. The apparatus of claim 9, wherein the processing circuitry being configured to determine the inconsistent schedule pattern comprises the processing circuitry being configured to select overlap periods that follow a consistent pattern for at least a threshold number of appointments and, for periods that do not follow the consistent pattern, select an alternative period having a relatively small amount of deviation from the consistent pattern.

14. The apparatus of claim 13, wherein an amount of deviation is based on a number of changes from the consistent pattern or a magnitude of change from the consistent pattern.

15. The apparatus of claim 9, wherein the processing circuitry is further configured to provide one or more scheduling options to a patient to enable the patient to select one of the one or more scheduling options.

16. A computer program product comprising at least one computer-readable storage medium having computer-executable program code instructions stored therein, the computer-executable program code instructions comprising program code instructions for:
receiving availability information defining available periods for a healthcare related asset;
receiving an appointment parameter defining a number and frequency of recurring appointments to be scheduled;
determining periods of overlap between the available periods and the appointment parameter; and
determining an inconsistent schedule pattern based on the periods of overlap.

17. The computer program product of claim 16, wherein program code instructions for receiving the appointment parameter include instructions for receiving practitioner constraints or patient constraints.

18. The computer program product of claim 16, wherein determining the inconsistent schedule pattern is performed responsive to an inability to determine a consistent schedule pattern.

19. The computer program product of claim 16, wherein program code instructions for determining the inconsistent schedule pattern include instructions for scoring alternative scheduling options based on an amount of deviation from a consistent schedule option.

20. The computer program product of claim 16, wherein program code instructions for determining the inconsistent schedule pattern include instructions for selecting overlap periods that follow a consistent pattern for at least a threshold number of appointments and, for periods that do not follow the consistent pattern, selecting an alternative period having a relatively small amount of deviation from the consistent pattern.

21. The computer program product of claim 20, wherein an amount of deviation is based on a number of changes from the consistent pattern or a magnitude of change from the consistent pattern.

22. The computer program product of claim 16, further comprising program code instructions for providing one or more scheduling options to a patient to enable the patient to select one of the one or more scheduling options.
